(19) United States
(12) Patent Application Publication
(10) Pub. No.: US 2024/0005319 A1
(43) Pub. Date: Jan. 4, 2024

(54) METHOD FOR SECURE PAYMENT, SECURE PAYMENT TERMINAL, AND NON-TRANSITORY COMPUTER READABLE STORAGE MEDIUM

(71) Applicant: PAX COMPUTER TECHNOLOGY (SHENZHEN) CO., LTD., Shenzhen, Guangdong (CN)

(72) Inventors: Jingyang LI, Shenzhen, Guangdong (CN); Xiaoyan SU, Shenzhen, Guangdong (CN); Xuan LV, Shenzhen, Guangdong (CN); Wantong XU, Shenzhen, Guangdong (CN); Xinpeng GUO, Shenzhen, Guangdong (CN); Xiansheng WU, Shenzhen, Guangdong (CN); Ruizhi TANG, Shenzhen, Guangdong (CN); Maohan HUANG, Shenzhen, Guangdong (CN)

(73) Assignee: PAX COMPUTER TECHNOLOGY (SHENZHEN) CO., LTD., Shenzhen, Guangdong (CN)

(21) Appl. No.: 18/021,749

(22) PCT Filed: Jul. 14, 2021
(86) PCT No.: PCT/CN2021/106164

§ 371 Date: Feb. 16, 2023

(30) Foreign Application Priority Data
Aug. 31, 2020 (CN) 202010895832.X

(51) Int. Cl. G06Q 20/40; G06Q 20/32

(52) U.S. Cl. CPC G06Q 20/401; G06Q 20/3226; G06Q 20/3221; G06Q 2220/00

(57) ABSTRACT

A method for secure payment, including: detecting whether a connected mobile terminal exists; acquiring, when the connected mobile terminal exists, a first user transaction information, and encrypting the first user transaction information to generate a corresponding first encrypted transaction information; sending the first encrypted transaction information to a transaction verification server based on a first hardware interface of the mobile terminal, and receiving a transaction verification result from the transaction verification server; and determining, according to the transaction verification result, whether a payment operation is to be performed.

### CROSS-REFERENCE TO RELATED APPLICATION

This application is a U.S. national phase of International Patent Application No. PCT/CN2021/106164 with an international filing date of Jul. 14, 2021, designating the U.S., now pending, and further claims the benefit of Chinese Patent Application No. 202010895832.X filed with China National Intellectual Property Administration on Aug. 31, 2020, the entire contents of which are incorporated herein by reference.

### TECHNICAL FIELD

The present application relates to the technical field of internet, and more particularly to a method and an apparatus for secure payment.

### BACKGROUND

With continuous development of Internet technologies, mobile payments have gradually infiltrated various aspects of people's live, and the functions of mobile terminals are increasingly powerful, such as the integrated functions of near field communication (NFC), face recognition, code scanning, and the like.

In addition, an intelligent POS is increasingly akin to a mobile phone and fully functional. Compared with a traditional POS terminal, the intelligent POS improves the merchant and user experience. However, the functions and hardware between the existing POS machine and the mobile terminal are completely independent and separated, and the POS machine and the mobile terminal have many hardware interfaces with overlapping functions (such as the communication modules), resulting in poor assembly flexibility and high manufacturing cost for the hardware of the overall payment device.

### SUMMARY

In view of the above, embodiments of the present application provides a method and an apparatus to secure payment, so as to tackle the problem that the payment device in the existing technology has interfaces with overlapping functions, poor assembly flexibility, and high production cost.

A first aspect of the present application provides a method for secure payment, being applied to a first secure payment module. The method includes:

detecting whether a connected mobile terminal exists;

acquiring, when the connected mobile terminal exists, a first user transaction information, and encrypting the first user transaction information to generate a corresponding first encrypted transaction information;

sending the first encrypted transaction information to a transaction verification server based on a first hardware interface of the mobile terminal, and receiving a transaction verification result from the transaction verification server; and

determining, according to the transaction verification result, whether a payment operation is to be performed.

A second aspect of the present application provides an apparatus for secure payment. The apparatus for secure payment includes: a mobile terminal detection unit, an encrypted transaction information generating unit, a hardware interface sharing unit, and a payment operation execution unit. The mobile terminal detection unit is configured for detecting whether a connected mobile terminal exists. The encrypted transaction information generating unit is configured for acquiring, when the connected mobile terminal exists, a first user transaction information, and encrypting the first user transaction information to generate a corresponding first encrypted transaction information. The hardware interface sharing unit is configured for sending the first encrypted transaction information to a transaction verification server based on a first hardware interface of the mobile terminal, and receiving a transaction verification result from the transaction verification server. The payment operation execution unit is configured for determining, according to the transaction verification result, whether a payment operation is to be performed.

A third aspect of embodiments of the present application provides a secure payment terminal. The secure payment terminal includes: a memory, a processor, and a computer program stored in the memory and executable by the processor. The processor is configured to implement the steps of the above method for secure payment when executing the computer program.

A third aspect of embodiments of the present application provides a computer-readable storage medium storing a computer program, which when being executed by a processor, causes the processor to implement the steps of the above method for secure payment.

A fifth aspect of embodiments of the present application provides a computer program product, which when being executed by a processor, causes the processor to implement the steps of the above method for secure payment.

Compared with the existing technology, beneficial effects of embodiments of the present application are summarized as follows:

The mobile terminal can share the first hardware interface with the first secure payment module, which has a relatively flexible assembling manner and can reduce the manufacturing cost of payment device. Moreover, in the process of payment, the mobile terminal cannot access transactions information in clear text, thus avoiding some security risks.

### BRIEF DESCRIPTION OF THE DRAWINGS

In order to more clearly illustrate the technical solutions in the embodiments of the present application, the drawings that need to be used in the description of the embodiments or the prior art will be briefly described hereinbelow. Obviously, the accompanying drawings in the following description are only some embodiments of the present application. For those skilled in the art, other drawings can be obtained based on these drawings without creative work.

FIG. 1 is a flowchart of an example of a method for secure payment according to an embodiment of the present application;

FIG. 2 is a flowchart of an example of a method for secure payment according to an embodiment of the present application;

FIG. 3 is a schematic diagram of a first example of communication interaction between a mobile terminal and multiple secure payment modules according to an embodiment of the present application;

FIG. 4 is a flowchart of an example of a method for secure payment according to an embodiment of the present application;

FIG. 5 is a schematic diagram of a second example of communication interaction between a mobile terminal and multiple secure payment modules according to an embodiment of the present application;

FIG. 6 is a schematic diagram of an example of an appearance design of a mobile terminal according to an embodiment of the present application;

FIG. 7 is a schematic diagram of an example of a secure payment module according to an embodiment of the present application;

FIG. 8 is a schematic structural diagram of an example of a combination of the mobile terminal shown in FIG. 6 and the secure payment module shown in FIG. 7;

FIG. 9 is a schematic structural diagram of an example of an apparatus for secure payment according to an embodiment of the present application;

FIG. 10 is a schematic diagram of an example of a secure payment terminal according to an embodiment of the present application.

### DETAILED DESCRIPTION OF THE EMBODIMENTS

In the following description, for the purpose of illustration rather than limitation, specific details such as specific system structures and technologies are set forth in order to provide a thorough understanding of the embodiments of the present application. However, it will be apparent to those skilled in the art that the present application may be practiced in other embodiments without these specific details. In other instances, detailed descriptions of well-known systems, devices, circuits, and methods are omitted so as not to obscure the description of the present application with unnecessary detail.

To illustrate the technical solutions of the present disclosure, specific embodiments will be described below.

It will be understood that the terms “comprise” when used in the specification and the appended claims, specifies the presence of stated features, integers, steps, operations, elements, and/or components, but does not preclude the presence or addition of one or more other features, integers, steps, operations, elements, components, and/or groups thereof.

The terminology used in the description of the disclosure herein is for the purpose of describing particular embodiments only and is not intended to be limiting of the invention. As used in the description of the disclosure and the appended claims, the singular forms “a”, “an” and “the” are intended to include the plural forms as well, unless the context clearly indicates otherwise.

It will also be understood that the term “and/or” as used in the description of the disclosure and the appended claims refers to and encompasses any and all possible combinations of one or more of the associated listed items.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In specific implementation, the mobile terminal described in the embodiments of the present disclosure includes, but is not limited to, mobile phones with touch-sensitive surfaces (for example, touch screen displays and/or touch pads), laptop computers, or other portable devices such as tablet computers. It should also be understood that in some embodiments, the above-mentioned devices are not portable communication devices but desktop computers with touch-sensitive surfaces (for example, touch screen displays and/or touch pads).

In the following discussion, a mobile terminal including a display and a touch-sensitive surface is described. However, it should be understood that the mobile terminal may include one or more other physical user interface device, such as a physical keyboard, a mouse, and/or a joystick.

Various applications that can be executed on the mobile terminal can use at least one common physical user interface device, such as a touch-sensitive surface. One or more functions of the touch-sensitive surface and corresponding information displayed on the terminal can be adjusted and/or changed between applications and/or within corresponding applications. In this way, the common physical architecture of the terminal (for example, a touch-sensitive surface) can support various applications with a user interface that is intuitive and transparent to the user.

In addition, in the descriptions of the present application, the terms “first”, “second”, “third”, and the like are merely intended for a purpose of differentiated description, but shall not be understood as an indication or an implication of relative importance.

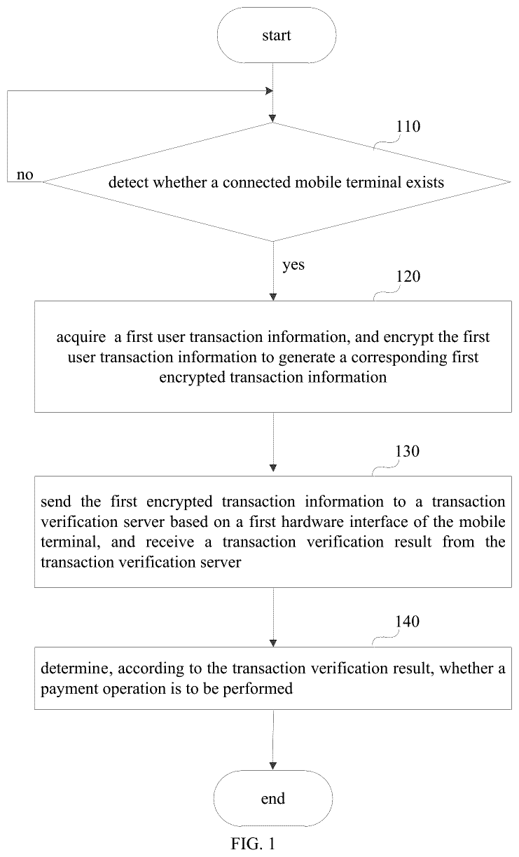

FIG. 1 is a flow chart of an example of a method for secure payment according to an embodiment of the present application. An execution subject of the method in the embodiment of the present application may be the secure payment module (in some examples, the first secure payment module). It should be understood that the term “first secure payment module” is not intended to limit the number of the secure payment modules, and may mean one or a plurality of the secure payment modules.

It should be understood that one or a plurality of security processors (SP) may be integrated in the secure payment module (or short for security module, SM). Herein, SP refers to a security trigger detection module, which may be powered by a backup battery all the time (24 hours a day) and detect the state of the device in real time. Moreover, once it is detected that the device is under attack, security information such as the key is erased, thereby ensuring the security of the user information.

In the current related art, an intelligent point-of-sale terminal is provided with an SP and an application processor (AP). Herein, the application processor supports an intelligent operating system (for example, an Android system) and has high security. However, all applications can be downloaded only after a signature is verified, and users cannot update and download the applications freely. In addition, a mobile phone POS (Contactless Payments on COTS) refers to a contactless payment performed on a commercial off-the-shelf (COTS) device, for example, a contactless transaction directly performed by using the near field communication (NFC) function of a mobile phone. However, the mobile phone POS only supports contactless and password-free transaction and no PIN can be entered, thus being unable to perform a large transaction.

In addition, in a software-based pin entry on COTS (SPOC) arrangement, PIN is entered at the mobile phone terminal to support applications' requirement for signature verification and the card reader supports ICCR, MSR, and CTLS, and PIN is not allowed to be entered when MSR is in use. However, the SPOC arrangement only supports online transactions, and the devices must be a mobile phone plus a card reader.

It should be understood that the mobile terminal may also be referred to as a commercial device (CD), which may be a mobile device (such as a smart phone or a tablet computer) or a desktop device (such as a cash register and a meal vending machine) designed for a common consumption market, and which may not be specially designed for payment processing, and may not be provided with a secure payment module. In addition, the mobile terminal generally supports a signature free function of an application, for example, the signature free requirement of the daily applications may be met based on a configured AP.

In some examples of the embodiments of the present application, the secure payment device may be interacted with the mobile terminal to complete the corresponding payment operation. In addition, the secure payment device may be referred to as a secure device (SD), which is a terminal allowing for password entry (PIN Entry) and/or processing account data, and is usually specially designed for payment processing, and may be provided with a secure processor (SP). The secure payment device may be a POS terminal, an intelligent POS terminal, a contactless card reader, an IC card reader, an MSR card reader, a password keyboard, and the like.

As shown in FIG. 1, in step 110, it is detected whether a connected mobile terminal exists.

If the detection result of step 110 indicates that the mobile terminal connected to the first secure payment module exists, then the method skips to step 120. If the detection result of step 110 indicates that no mobile terminal is connected to the first secure payment module, then the method skips to step 110 for continuous monitoring.

In step 120, a first user transaction information is acquired, and the first user transaction information is encrypted to generate a corresponding first encrypted transaction information;

Herein, the secure payment module can be provided with user input components (for example, button components), so that user transaction information (for example, account numbers or passwords) can be input by the user through the secure payment module, and then encrypted by the security chip in the secure payment module correspondingly.

In some examples of embodiments of the present application, the transaction request may be triggered by the mobile terminal, and the secure payment module may also receive corresponding non-sensitive transaction information (such as transaction amount) from the mobile terminal. Combined with the application scenario, a transaction request is generated by the mobile terminal based on the transaction amount (for example, the user enters the transaction amount through the mobile terminal's payment application), and sent to the secure payment module to confirm the transaction amount. After confirming the transaction amount, the user can continue to input, into the secure payment module, the transaction sensitive information (for example, the account and the password), which is used to realize the payment operation. Then the account and the password are encrypted by the secure payment module to generate corresponding encrypted transaction information. In the present application scenario, although the transaction request is initiated by the mobile terminal, the mobile terminal cannot obtain sensitive information in a clear text, which can ensure the security and reliability of the transaction.

In step 130, the first encrypted transaction information is sent to a transaction verification server based on a first hardware interface of the mobile terminal, and a transaction verification result is received from the transaction verification server.

Herein, the hardware interface may refer to a hardware module for realizing various functions, such as a communication hardware interface, a voice hardware interface, and the like. In addition, in some implementations, in order to ensure high reliability during the payment operation, the first hardware interface may also refer to a hardware interface that has nothing to do with the payment function, that is, sensitive information in in the clear text cannot be obtained through the first hardware interface. Exemplarily, the first hardware interface may not be a camera for obtaining facial data, or a contactless card reader for reading IC card numbers, or a touch screen or keyboard for receiving passwords.

In an example of the embodiment of the present application, the mobile terminal is configured with a communication module, and when the mobile terminal establishes a connection with the secure payment module, the secure payment module can share the communication module in the mobile terminal, without requiring additional redundant arrangement in the secure payment device, thereby saving the manufacturing cost of the secure payment device.

In step 140, it is determined whether a payment operation is to be performed, according to the transaction verification result. Exemplarily, if the verification passes, the payment operation is performed; and if the verification fails, the payment operation is stopped.

Combined with the application scenario, the user can enter the password through the secure payment module, and get the account number by swiping the card, and then the secure payment module can encrypt the password and account number and package them in a certain format, which are then forwarded to a transaction verification background by using the communication module in the mobile terminal (for example, Wi-Fi, 4G module, and the like).

It should be understood that the mobile terminal can exchange any type of data with the first secure payment module through various communication methods (for example, WIFI, Bluetooth, the infrared communication method, the cable communication method, and the like) to support corresponding payment function, which shall not be limited herein.

In some examples of the embodiment of the present application, the secure payment module and the mobile terminal share hardware interfaces, such as a 4G module, a WIFI module, a BT module, and a voice module. It should be noted that the types of hardware interfaces described herein are only exemplary, rather than limitations. For example, other types of hardware interfaces not listed in the present application can also be shared between the mobile terminal and the secure payment module.

In this embodiment of the present application, the secure payment module can share an interface with the mobile terminal, thus avoiding duplication of hardware interfaces and saving the manufacturing cost of the secure payment device. In addition, the secure payment module can be flexibly designed according to the shared hardware interface, thus having high assembly flexibility. In addition, during the entire payment process, the mobile terminal cannot access the transaction information in clear text, which also ensures the security and reliability in some payment scenarios.

In some application scenarios, such as scenarios with high security requirements, the information (for example, transaction information) of the mobile terminal may need to be verified by a plurality of secure payment modules before the payment operation can be completed.

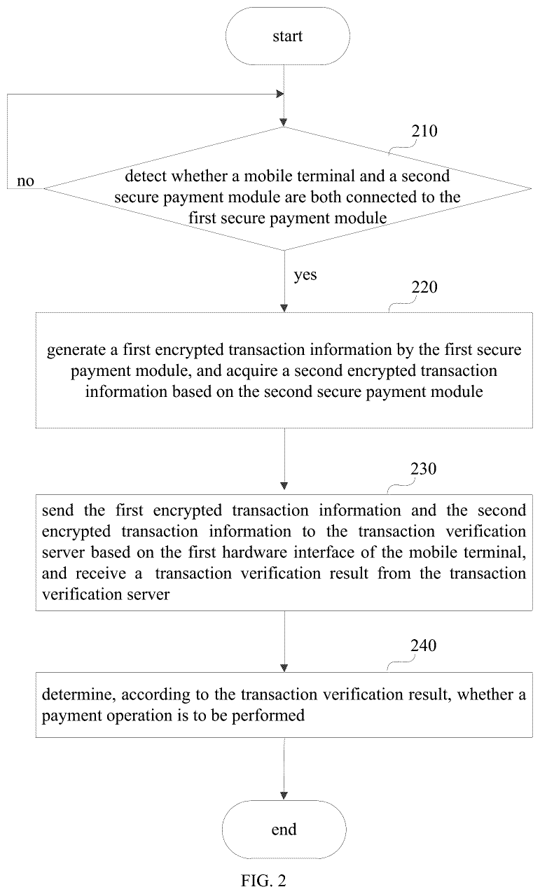

FIG. 2 is a flowchart of an example of a method for secure payment according to an embodiment of the present application.

In step 210, it is detected whether a mobile terminal and a second secure payment module are both connected to the first secure payment module.

If the detection result of step 210 indicates that both the mobile terminal and the second secure payment module are connected with the first secure payment module, then the method skips to step 220. If the detection result of step 210 indicates that either the mobile terminal or the second secure payment module is not connected with the first secure payment module, then the method skips to step 210 to continue the detection.

In step 220, a first encrypted transaction information is generated by the first secure payment module, and a second encrypted transaction information is acquired based on the second secure payment module. Herein, the second encrypted transaction information is acquired by encrypting the acquired second user transaction information by the second secure payment module.

It should be noted that in the embodiment of the present application, the first secure payment module and the second secure payment module can be integrated as a whole, and can perform encryption processing on the user transaction information respectively by their respective security functions (for example, calling the security chip).

In step 230, the first encrypted transaction information and the second encrypted transaction information are sent to the transaction verification server based on the first hardware interface of the mobile terminal, and the transaction verification result is received from the transaction verification server. Exemplarily, the transaction verification server can decrypt and verify the first encrypted transaction information and the second encrypted transaction information respectively, and when all the encrypted transaction information is matched and safe, the corresponding transaction verification result can be that the transaction verification passes.

In step 240, it is determined, according to the transaction verification result, whether a payment operation is to be performed.

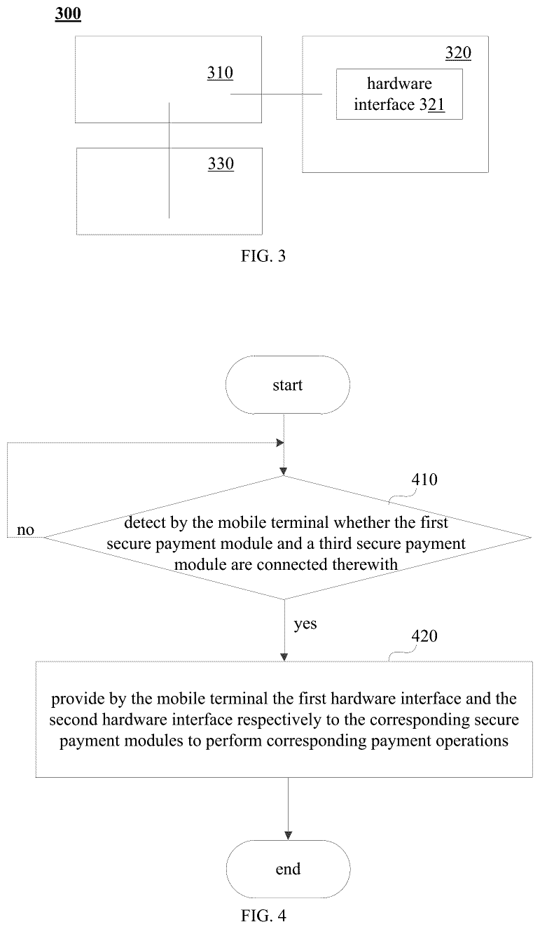

FIG. 3 is a schematic diagram of a first example of communication interaction between a mobile terminal and multiple secure payment modules according to an embodiment of the present application.

As shown in the architecture 300 of FIG. 3, the mobile terminal 320 can share a hardware interface 321 with a secure payment module 310, and the secure payment module 310 is connected to another secure payment module 330. In this way, the mobile terminal 320 can call the secure payment module 310 through the hardware interface 321, and call another security module 330 connected with the secure payment module 310.

In some application scenarios, different secure payment modules can be combined into an overall secure payment device, and then the combined device can be used to connect with the mobile terminal and share part of the hardware interfaces. When processing the payment operations, after the first stage of security processing is performed using the above combined device, the next stage of security processing operations can be carried out through another secure payment module, and the security and the reliability of the payment operations are higher. Thus, the payment function can be modularized, making the combination of the secure payment module and the mobile terminal (for example, the mobile terminal can be coupled with corresponding secure payment modules) very flexible and more convenient for practical use.

In this embodiment of the present application, different secure payment modules can be directly combined with each other, and after the combination is completed, the combined secure payment modules can share the hardware interface with the mobile terminal, so that the hardware interface of the mobile terminal can be shared by the multiple secure payment modules at the same time, and a variety of encrypted transaction information can be used for verification at the same time, which can meet a wider range of personalized security payment scenarios.

FIG. 4 is a flowchart of an example of a method for secure payment according to an embodiment of the present application. In the embodiment of the present application, the mobile terminal has a plurality of hardware interfaces, each of the plurality of hardware interfaces is configured to be called by a secure payment module of a corresponding type. That is to say, the mobile terminal can have a plurality of hardware interfaces shared with different secure payment modules.

As shown in FIG. 4, in step 410, the mobile terminal detects whether the first secure payment module and a third secure payment module are connected therewith. Herein, the first secure payment module and the mobile terminal share a first payment hardware interface, and the third secure payment module and the mobile terminal share the second payment hardware interface.

If the detection result in step 410 indicates that the first secure payment module and the third secure payment module are connected with the mobile terminal, then the secure payment method skips to step 420. If the detection result in step 410 indicates that either the first secure payment module or the third secure payment module is connected to the mobile terminal, then the secure payment method skips to step 410.

In step 420, the mobile terminal respectively provides the first hardware interface and the second hardware interface to the corresponding secure payment modules to perform corresponding payment operations.

In some application scenarios, in order to ensure the security of the transaction, the transaction verification server needs to obtain the transaction information transmitted by the first secure payment module and the third secure payment module at the same time, so as to complete the corresponding payment operations.

In this embodiment of the present application, the mobile terminal can be provided with multiple hardware interfaces for sharing with different secure payment modules, which can meet some personalized needs of merchants and users.

In some examples of the embodiments of the present application, the mobile terminal supports a signature free function of at least one payment application. In addition, the mobile terminal may not be used to process payment-related sensitive data or sensitive services (such as PIN input and account data input) to ensure transaction security. As a result, the signature free requirement of the daily application, as well as the high security of payment-related transactions, can be met, so that merchants and users can have better payment experiences.

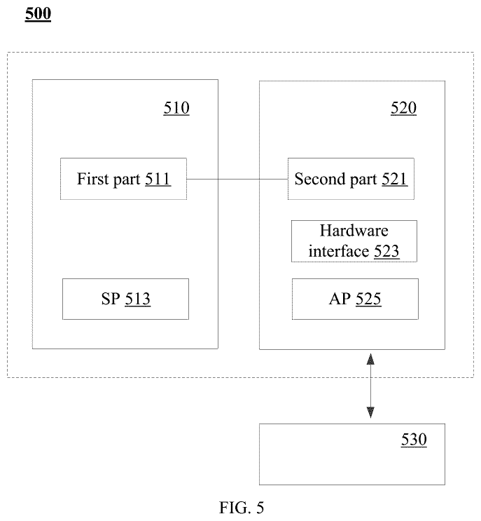

FIG. 5 is a schematic diagram of a second example of communication interaction between a mobile terminal and multiple secure payment modules according to an embodiment of the present application.

As shown in FIG. 5, the secure payment system 500 includes a first secure payment module 510 and a mobile terminal 520, the first secure payment module 510 is provided with a first part 511, and the mobile terminal 520 is provided with a second part 521 matching with the first part 511.

In some examples of embodiments of the present application, the first secure payment module 510 can support transaction information input functions, such as password input functions and/or account number input functions. For example, a PIN can be input through a physical button or a touch screen, the card reader supports the MSR, CTLS, or ICCR type, the camera supports face collection or QR code reading. In addition, in the secure payment module 510, an SP 513 is also provided to ensure the security of user information.

Herein, when the first part 511 and the second part 521 are engaged, the first secure payment module 510 is connected with the mobile terminal 520, and the hardware interface 523 shared between the first secure payment module 510 and the mobile terminal 520 is activated.

In some embodiments, the first secure payment module 510 may determine whether a connected mobile terminal exists, by detecting whether the second part 521 in engaged with the first part 511.

In some examples of the embodiment of the present application, the first part and the second part may be a portion of a shared hardware interface, for example, the first part and the second part are respectively a part of a PCB circuit board of a certain hardware interface, when the first part and the second part are engaged, the hardware interface may be conducted and activated.

Although the number of the first secure payment module 510 in FIG. 5 is only one, it should be understood that the number of the first secure payment module in the first security device can be plural, and the mobile terminal 520 can be engaged with a plurality of first secure payment modules via the second part, respectively.

In some embodiments, the secure payment system 500 also includes a third secure payment module 530. In an example of the embodiment of the present application, the third secure payment module 530 may not share a hardware interface with the mobile terminal 520, in such case, after the first secure payment module 510 and the mobile terminal 520 are connected to share a hardware interface 523, the first secure payment module 510 and the mobile terminal 520 can be used as a whole to communicate with the third payment module 530. In another example of the embodiment of the present application, both the first secure payment module 510 and the third secure payment module 530 can share corresponding hardware interfaces with the mobile terminal 520.

In some examples of the embodiments of the present application, the AP 525 in the mobile terminal 520 may also support the signature free function of the application.

In some examples of the embodiments of the present application, the first part and the second part may be engaged through at least one of the following: a metal contact, a snap joint, an elastic pin, and a PCB.

It should be noted that the above engagement manners between the first part and the second part are merely exemplary, and are not limitations to the implementation scope of the embodiments of the present application. For example, the first part and the second part may also be engaged by other means not described herein, which are all within the protection scope of the present application.

Therefore, various engagement manners can be implemented between the secure payment device and the mobile terminal, and requirements of personalized application service scenarios can be satisfied.

In some examples of the embodiment of the present application, the first part 511 can be a casing structure of the first secure payment module, and the second part 521 can be a groove structure which is arranged at a casing body of the mobile terminal and matches with the casing structure of the first secure payment module.

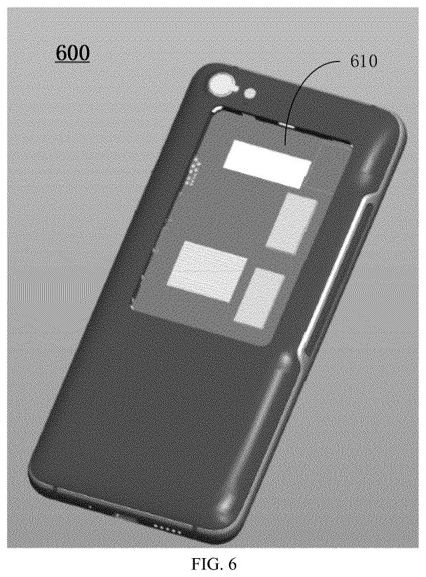

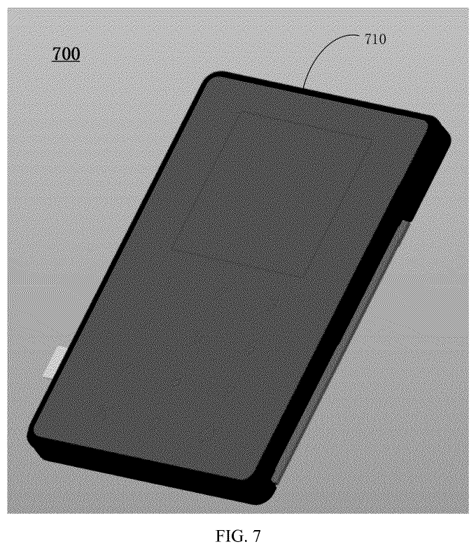

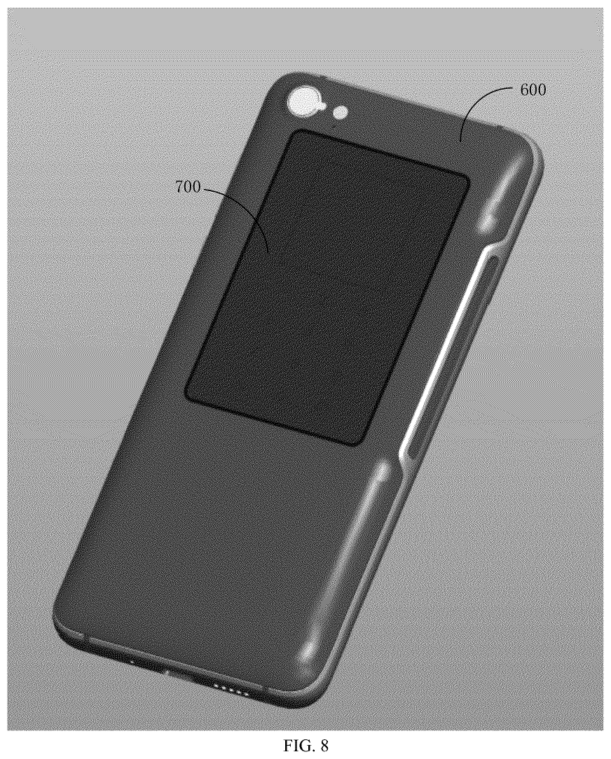

FIG. 6 is a schematic diagram of an example of an appearance design of a mobile terminal according to an embodiment of the present application. FIG. 7 is a schematic diagram of an example of a secure payment module according to an embodiment of the present application. FIG. 8 is a schematic structural diagram of an example of a combination of the mobile terminal shown in FIG. 6 and the secure payment module shown in FIG. 7.

As shown in the figure, a groove structure 610 is defined in the mobile terminal 600, and the secure payment module 700 is provided with a casing structure 710. The groove structure 610 matches with the casing structure 710, so that the secure payment module 700 can be embedded in the mobile terminal.

It should be noted that the mobile terminal (CD) and the secure payment module (SM) can establish a communication connection in various ways, for example, the SM and the CD are connected through an FPC, a cable, a relay PCB, a spring pin, a metal contact or other intermediate structural components or transfer devices, or alternatively, the SM and the CD can be connected wirelessly through WIFI, BT or infrared wireless connections. Exemplarily, an FPC may be provided on the SM, and a corresponding slot may be provided on the CD, and the SM and the CD can be combined by insertion through the FPC cable.

In addition, various firmware (not shown), such as an AP 1 with secure boot or with a SP-controlled boot, may also be provided in the secure payment module. Here, SP and AP 1 are separate ICs or integrated ICs. Preferably, the secure payment device may further be provided with various peripheral device components, such as components for supporting functions such as communication, power supply, voice, storage, display, printing, biometric identification, storage and etc., and may also be configured to have an anti-removal software and hardware design.

In some examples of the embodiments of the present application, the mobile terminal may also be provided with various peripheral device parts (not shown), such as parts for supporting functions such as communication, power supply, voice, storage, display, printing, biometric identification, storage, NFC, and the like, and may also be configured to have an anti-removal software and hardware design. Preferably, an AP 3 may be configured for supporting applications' requirement for signature verification.

It should be noted that a part of the secure payment modules in the secure payment device and the mobile terminal are not independent wholes, but share a part of the hardware interface modules, which contain payment related and non-payment related modules, but are not completely physically independent and isolated. In addition, part of the secure payment modules are independent wholes, which are independent from remaining SM and CD, and are physically completely isolated.

Herein, a part of the secure payment modules and the mobile terminal can be combined (or engaged) in various ways, and some or all of the functional modules (such as PCB circuit boards) can be shared between the SM and the CD. In addition, the SM and the CD are physically bound together by a buckle, a tape, glue, or laser welding. In addition, a part or all of the casing can be shared between the SM and the CD. In addition, SM and CD can also be wrapped by a component or other one or more devices so as to combine the SM and CD into an integrated device.

It should be noted that the term “the secure payment module” or “SM” and the term “secure payment device” or “SD” described in the embodiments of the present application can replace with each other, and both terms belong to the implementation scope of the embodiments of the present application. Exemplarily, the “secure payment module” described in FIG. 7 may also be referred to as the “secure payment device” in some cases.

By using the secure payment system of the embodiments of the present application, the secure payment module in the secure payment device and the mobile terminal are combined and share a hardware interface, which can reduce hardware cost and hardware volume, and improve flexibility. In addition, a merchant may have a better user experience, not only can the daily applications' signature free function can be met, but also the need for high security of payment related transactions can be met. Also, multiple payment application forms are provided, which reduces the number of devices used by merchants, and can also meet the multiple requirements from different markets and users.

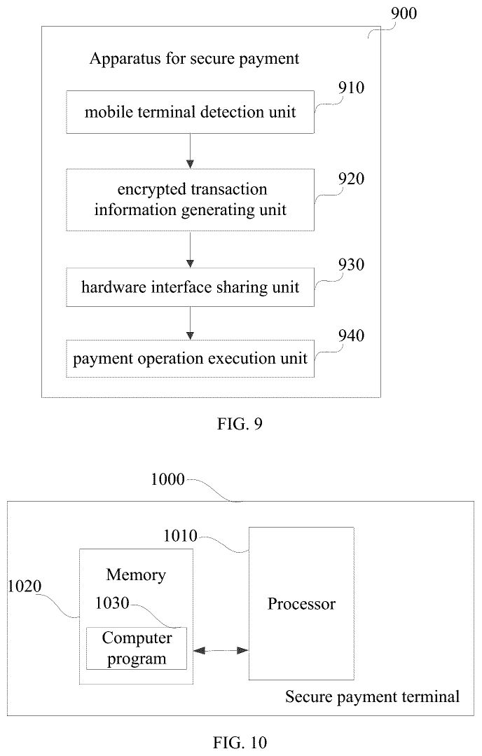

FIG. 9 is a schematic structural diagram of an example of an apparatus for secure payment according to an embodiment of the present application.

As shown in FIG. 9, the secure payment apparatus 900 comprises: a mobile terminal detection unit 910, an encrypted transaction information generating unit 920, a hardware interface sharing unit 930, and a payment operation execution unit 940.

The mobile terminal detection unit 910 is configured for detecting whether a connected mobile terminal exists.

The encrypted transaction information generating unit 920 is configured for acquiring, when the connected mobile terminal exists, a first user transaction information, and encrypting the first user transaction information to generate a corresponding first encrypted transaction information.

The hardware interface sharing unit 930 is configured for sending the first encrypted transaction information to a transaction verification server based on a first hardware interface of the mobile terminal, and receiving a transaction verification result from the transaction verification server.

The payment operation execution unit 940 is configured for determining, according to the transaction verification result, whether a payment operation is to be performed.

It should be noted that the information interaction and execution process between the above-mentioned devices/units are based on the same concept as the method embodiment of the present application, and the specific functions and the technical effects thereof can be referred to the part of the method embodiment, thus not being repeated herein again.

FIG. 10 is a schematic diagram of an example of a secure payment terminal according to an embodiment of the present application. As shown in FIG. 10, the secure payment terminal 100 comprises: a processor 1010, a memory 1020, and a computer program 1030 stored in the memory 1020 and executable by the processor 1010. The processor 1010 is configured to implement the steps of the method for secure payment in the above embodiments when executing the computer program 1030, for example, steps 110-130 as shown in FIG. 1. Or alternatively, the functions of the modules/devices of the apparatus for secure payment in the above embodiments can be realized when the processor 1010 executes the computer program 1030, for example, the functions of units 910-940 as shown in FIG. 9.

Exemplarily, the computer program 1030 can be divided into one or more modules/units, and the one or more modules/units are stored in the memory 1020 and executed by the processor 1010 to implement the method of the present application. The one or more modules/units may be a series of computer program instruction segments capable of accomplishing specific functions, and the instruction segments are used to describe the execution process of the computer program 1030 in the secure payment terminal 1000. For example, the computer program 1030 can be divided into a mobile terminal detection module, an encrypted transaction information generating module, a hardware interface sharing module, and a payment operation execution module. The specific functions thereof are as follows:

the mobile terminal detection module, configured for detecting whether a connected mobile terminal exists;

the encrypted transaction information generating module, configured for acquiring, when the connected mobile terminal exists, a first user transaction information, and encrypting the first user transaction information to generate a corresponding first encrypted transaction information;

the hardware interface sharing module, configured for sending the first encrypted transaction information to a transaction verification server based on a first hardware interface of the mobile terminal, and receiving a transaction verification result from the transaction verification server; and

the payment operation execution module, configured for determining, according to the transaction verification result, whether a payment operation is to be performed.

The secure payment terminal 1000 may be a computing device such as a desktop computer, a notebook computer, a tablet computer, and a cloud server. The secure payment terminal 1000 may include, but is not limited to, a processor 1010 and a memory 1020. It can be understood by those skilled in the art that FIG. 10 is merely an example of the secure payment terminal 1000 and does not constitute any limitation on the secure payment terminal 1000, and may include more or fewer parts than those shown in the figure, or a combination of some parts or different parts. For example, the secure payment terminal 1000 may further include an input/output device, a network access device, a bus, and the like.

The processor 1010 may be a central processing unit (CPU), or be other general-purpose processor, a digital signal processor (DSP), an application specific integrated circuit (ASIC), a field-programmable gate array (FPGA), or be other programmable logic device, a discrete gate or transistor logic device, a discrete hardware component, and the like. The general-purpose processor may be a microprocessor, or the processor may also be any conventional processor.

The memory 1020 may be an internal storage unit of the secure payment terminal 1000, for example, a hard disk or a memory of the secure payment terminal 1000. The memory 1020 may also be an external storage device of the secure payment terminal 1000, for example, a plug-in hard disk, a smart media card (SMC), a secure digital (SD) card, a flash card, and the like, which is provided on the secure payment terminal 1000. Further, the memory 1020 may include both the internal storage unit and the external storage device of the secure payment terminal 1000. The memory 1020 is configured to store the computer program and other programs and data required by the secure payment terminal 1000. The memory 1020 may also be used to temporarily store data that has been or will be output.

Those skilled in the art may clearly understand that, for the convenience and simplicity of description, the division of the above-mentioned functional units or modules is merely an example for illustration. In actual applications, the above-mentioned functions may be allocated to be performed by different functional units or modules according to requirements, that is, the internal structure of the apparatus may be divided into different functional units or modules to complete all or part of the above-mentioned functions. The functional units or modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit or module is merely for the convenience of distinguishing each other and are not intended to limit the scope of protection of the present disclosure. For the specific operation process of the units or modules in the above-mentioned system, reference may be made to the corresponding processes in the above-mentioned method embodiments.

In the above-mentioned embodiments, the description of each embodiment has its focuses, and for the parts which are not described or mentioned in one embodiment, the related descriptions in other embodiments may be referred to.

Those skilled in the art may understand that, the exemplary units and steps described in the embodiments disclosed herein may be implemented through electronic hardware or a combination of computer software and electronic hardware. Whether these functions are implemented through hardware or software depends on the specific application and design constraints of the technical schemes. Those skilled in the art may implement the described functions in different manners for each particular application, while such implementation should not be considered as beyond the scope of the present disclosure.

In the embodiments provided by the present disclosure, it should be understood that the disclosed apparatus/secure payment terminal and method may be implemented in other manners.

For example, embodiments of the above-mentioned apparatus/secure payment terminal are merely exemplary. For example, the division of modules or units is merely a logical functional division, and other division manner may be used in actual implementations, for example, multiple units or components may be combined or be integrated into another system, or some of the features may be ignored or not performed. In addition, the shown or discussed mutual coupling or direct coupling or communication connection may be indirect coupling or communication connection through some interfaces, apparatus or units, and may also be electrical, mechanical, or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a computer-readable storage medium. Based on this understanding, all or part of the processes of the method for implementing the above-mentioned embodiments of the present disclosure may also be implemented by instructing relevant hardware through a computer program. The computer program may be stored in a computer-readable storage medium, which may implement the steps of each of the above-mentioned method embodiments when executed by a processor.

The computer program includes computer program codes which may be in the form of source codes, object codes, executable files, or certain intermediate and the like. The computer-readable medium may include any primitive or apparatus capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

1. A method for secure payment, being applied to a first secure payment module, the method comprising:
detecting whether a mobile terminal is connected with the first secure payment module;
acquiring, when the mobile terminal exists, a first user transaction information, and encrypting the first user transaction information to generate a corresponding first encrypted transaction information;
sending the first encrypted transaction information to a transaction verification server based on a first hardware interface of the mobile terminal, and receiving a transaction verification result from the transaction verification server; and
determining, according to the transaction verification result, whether a payment operation is to be performed.

2. The method for secure payment of claim 1, further comprising:
detecting whether a second secure payment module is connected with the first secure payment module;
acquiring, when a detection result indicates that the second secure payment module is connected with the first secure payment module, a second encrypted transaction information based on the second secure payment module; wherein the second encrypted transaction information is obtained by encrypting a second user transaction information by the second secure payment module; and
correspondingly, the step of sending the first encrypted transaction information to the transaction verification server based on the first hardware interface of the mobile terminal, and receiving the transaction verification result from the transaction verification server, comprising:
sending the first encrypted transaction information and the second encrypted transaction information to the transaction verification server based on the first hardware interface of the mobile terminal, and receiving the transaction verification result from the transaction verification server.

3. The method for secure payment of claim 1, wherein the mobile terminal has a plurality of hardware interfaces, and each of the plurality of hardware interfaces is configured to be called by a secure payment module of a corresponding type.

4. The method for secure payment of claim 1, wherein the mobile terminal supports a signature free function of at least one payment application.

5. The method for secure payment of claim 1, wherein the first secure payment module is provided with a first part, and the mobile terminal is provided with a second part matching with the first part;
the step of detecting whether the mobile terminal is connected with the first secure payment module comprises:
detecting whether the second part engaged with the first part exists, wherein a detection result is used to correspondingly determine whether the mobile terminal is connected with the first secure payment module.

6. The method for secure payment of claim 5, wherein the first part is a casing structure of the first secure payment module, and the second part is a groove structure, which is arranged at a casing body of the mobile terminal and matches with the casing structure of the first secure payment module.

7. The method for secure payment of claim 5, wherein the first part and the second part may be engaged through at least one of the following: a metal contact, a snap joint, an elastic pin, and a PCB.

8. (canceled)

9. A secure payment terminal, provided with at least one secure payment module, and comprising: a memory, a processor, and a computer program stored in the memory and executable by the processor, wherein the processor is configured to implement a method for secure payment when executing the computer program-, and the method for secure payment comprises the following steps:
detecting whether a mobile terminal is connected with a first secure payment module;
acquiring, when the mobile terminal exists, a first user transaction information, and encrypting the first user transaction information to generate a corresponding first encrypted transaction information;
sending the first encrypted transaction information to a transaction verification server based on a first hardware interface of the mobile terminal, and receiving a transaction verification result from the transaction verification server; and
determining, according to the transaction verification result, whether a payment operation is to be performed.

10. A non-transitory computer-readable storage medium storing a computer program, which when being executed by a processor, causes the processor to implement a method for secure payment, and the method for secure payment comprises the following steps:
detecting whether a mobile terminal is connected with a first secure payment module;
acquiring, when the mobile terminal exists, a first user transaction information, and encrypting the first user transaction information to generate a corresponding first encrypted transaction information;
sending the first encrypted transaction information to a transaction verification server based on a first hardware interface of the mobile terminal, and receiving a transaction verification result from the transaction verification server; and
determining, according to the transaction verification result, whether a payment operation is to be performed.

11. The secure payment terminal of claim 9, wherein the method for secure payment further comprises:
detecting whether a second secure payment module is connected with the first secure payment module;
acquiring, when a detection result indicates that the second secure payment module is connected with the first secure payment module, a second encrypted transaction information based on the second secure payment module; wherein the second encrypted transaction information is obtained by encrypting a second user transaction information by the second secure payment module; and
correspondingly, the step of sending the first encrypted transaction information to the transaction verification server based on the first hardware interface of the mobile terminal, and receiving the transaction verification result from the transaction verification server, comprising:
sending the first encrypted transaction information and the second encrypted transaction information to the transaction verification server based on the first hardware interface of the mobile terminal, and receiving the transaction verification result from the transaction verification server.

12. The secure payment terminal of claim 9, wherein the mobile terminal has a plurality of hardware interfaces, and each of the plurality of hardware interfaces is configured to be called by a secure payment module of a corresponding type.

13. The secure payment terminal of claim 9, wherein the mobile terminal supports a signature free function of at least one payment application.

14. The secure payment terminal of claim 9, wherein the first secure payment module is provided with a first part, and the mobile terminal is provided with a second part matching with the first part;
the step of detecting whether the mobile terminal is connected with the first secure payment module comprises:
detecting whether the second part engaged with the first part exists, wherein a detection result is used to correspondingly determine whether the mobile terminal is connected with the first secure payment module.

15. The secure payment terminal of claim 14, wherein the first part is a casing structure of the first secure payment module, and the second part is a groove structure, which is arranged at a casing body of the mobile terminal and matches with the casing structure of the first secure payment module.

16. The secure payment terminal of claim 14, wherein the first part and the second part may be engaged through at least one of the following: a metal contact, a snap joint, an elastic pin, and a PCB.

17. The non-transitory computer-readable storage medium of claim 10, wherein the method for secure payment further comprises:
detecting whether a second secure payment module is connected with the first secure payment module;
acquiring, when a detection result indicates that the second secure payment module is connected with the first secure payment module, a second encrypted transaction information based on the second secure payment module; wherein the second encrypted transaction information is obtained by encrypting a second user transaction information by the second secure payment module; and
correspondingly, the step of sending the first encrypted transaction information to the transaction verification server based on the first hardware interface of the mobile terminal, and receiving the transaction verification result from the transaction verification server, comprising:
sending the first encrypted transaction information and the second encrypted transaction information to the transaction verification server based on the first hardware interface of the mobile terminal, and receiving the transaction verification result from the transaction verification server.

18. The non-transitory computer-readable storage medium of claim 10, wherein the mobile terminal has a plurality of hardware interfaces, and each of the plurality of hardware interfaces is configured to be called by a secure payment module of a corresponding type.

19. The non-transitory computer-readable storage medium of claim 10, wherein the mobile terminal supports a signature free function of at least one payment application.

20. The non-transitory computer-readable storage medium of claim 10, wherein the first secure payment module is provided with a first part, and the mobile terminal is provided with a second part matching with the first part;
the step of detecting whether the mobile terminal is connected with the first secure payment module comprises:
detecting whether the second part engaged with the first part exists, wherein a detection result is used to correspondingly determine whether the mobile terminal is connected with the first secure payment module.

21. The non-transitory computer-readable storage medium of claim 20, wherein the first part is a casing structure of the first secure payment module, and the second part is a groove structure, which is arranged at a casing body of the mobile terminal and matches with the casing structure of the first secure payment module.
